(19) United States
(12) Patent Application Publication
(10) Pub. No.: US 2014/0188777 A1
(43) Pub. Date: Jul. 3, 2014

(54) METHODS AND SYSTEMS FOR IDENTIFYING A PRECURSOR TO A FAILURE OF A COMPONENT IN A PHYSICAL SYSTEM

(71) Applicant: GENERAL ELECTRIC COMPANY, Schenectady, NY (US)

(72) Inventors: Weizhong Yan, Clifton Park, NY (US); Anil Varma, San Ramon, CA (US); Brock Estel Osborn, Niskayuna, NY (US); James Kenneth Aragones, Clifton Park, NY (US); Piero Patrone Bonissone, Schenectady, NY (US); Naresh Sundaram Iyer, Saratoga Springs, NY (US); Hai Qiu, Clifton Park, NY (US)

(73) Assignee: GENERAL ELECTRIC COMPANY, Schenectady, NY (US)

(21) Appl. No.: 13/728,572

(22) Filed: Dec. 27, 2012

(51) Int. Cl. G06N 5/02

(52) U.S. Cl. CPC G06N 5/02
USPC 706/50

(57) ABSTRACT

A computer-implemented system for identifying a precursor to a failure of a particular type of component in a physical system is provided. The physical system includes sensors coupled to the physical system. The computer-implemented system includes a computing device, a database, a processor, and a memory device. The memory device includes historical data including sensor measurements. When instructions are executed by the processor, the processor receives the historical data from the memory device. The processor generates a predictive model. The predictive model uses, as inputs, sensor measurements in the historical data. The predictive model is able to differentiate between sensor measurements taken before the repair event and those taken after the repair event without a time of the repair event being an input to the predictive model. The processor designates at least one sensor measurements used as inputs to the predictive model as precursors to the failure of the component.

### BACKGROUND

The field of the invention relates generally to maintenance of components of a physical system, and more particularly, to a computer-implemented system for identifying a precursor to a failure of a particular type of component in a physical system.

Many known complex physical systems, such as aircraft, automobiles, and physical systems used in industrial plants, include multiple components that perform repetitive functions. Over time, it is possible for the components to wear such that they approach the end of useful life. In many instances, sensors are included within, coupled to, or otherwise in the vicinity of a physical system and electronically transmit sensor measurements, i.e., measurement data determined by the sensor, to a central computing device for evaluation. For many components, the set of sensors or measurements that carry information related to the component's health and thus remaining useful life might be previously known. For example, increasing vibration sensor measurements collected by a sensor over a given time period may be used to infer that a particular bearing in a physical system is wearing out and will approach the end of useful life within a month. However, for many other components, the existing measurements or sensors that carry information related to the health or degradation of the component might not be known a priori. In fact, one needs to look at the entire potential set of sensor measurements and construct or synthesize the health of the component using advanced models that map these diverse set of sensors to component health. This process of constructing such a model is extremely complex due to many factors including the amount of data involved, the need to select the relevant subset of sensors to use in the modeling from a long and combinatorially complex list and the complexity of modeling approaches that have to be used.

In other known complex physical systems, sensors included within, coupled to, or otherwise in the vicinity of the physical system electronically send sensor measurements to a central computing device for programmatic evaluation. While many known software programs implementing a programmatic evaluation have the ability to process significant amounts of data, many software programs lack the knowledge of human experts regarding the sensors measurements and the interactions between sensor measurements to be used for estimating the useful life of the component. As a result, these other known complex physical systems may process sensor measurements but lack an ability to detect the sensor measurements most associated with the failure of a component. Although some known software programs can be taught to look for specific sensor measurements, such some known software programs are dependent upon a domain of knowledge, i.e., the area of expert knowledge specific to a field of inquiry that is utilized for particular sensor measurement analysis.

### BRIEF DESCRIPTION

In one aspect, a computer-implemented system for identifying a precursor to a failure of a particular type of component in a physical system is provided. The physical system includes a plurality of sensors coupled to components of the physical system. The computer-implemented system includes a computing device, a database associated with the computing device, a processor coupled to the computing device, and a memory device coupled to the processor and the computing device. The memory device includes historical data including sensor measurements from the plurality of sensors over a time period. The time period at least spans the operation of a replaced component of the particular type immediately preceding and immediately following a repair event in which the replaced component failed and was replaced. The memory device further includes processor-executable instructions. When the processor-executable instructions are executed by the processor, the processor receives the historical data from the memory device. The processor then generates a predictive model. The predictive model uses, as inputs, sensor measurements in the historical data. The predictive model is able to differentiate between sensor measurements taken before the repair event and sensor measurements taken after the repair event without a time of the repair event being an input to the predictive model. The processor then designates at least one sensor measurements used as inputs to the predictive model as precursors to the failure of the particular type of component.

In another aspect, a computer-implemented method for identifying a precursor to a failure of a particular type of component in a physical system is provided. The physical system includes a plurality of sensors coupled to components of the physical system. The method is performed by a computing device. The computing device includes a processor coupled to a memory device and is associated with a database. The memory device includes historical data including sensor measurements from the plurality of sensors over a time period. The time period at least spans an operation of a replaced component of the particular type immediately preceding and immediately following a repair event in which the replaced component failed and was replaced. The method includes receiving the historical data from the memory device. The method further includes generating a predictive model which uses as inputs sensor measurements in the historical data. The predictive model is able to differentiate between sensor measurements taken before the repair event and sensor measurements taken after the repair event without a time of the repair event being an input to the predictive model. The method additionally includes designating at least one sensor measurement used as inputs to the predictive model as precursors to the failure of the particular type of component.

In another aspect, a computer-readable storage device having processor-executable instructions embedded thereon is provided. At least one processor coupled to a memory device in a computing device may execute the processor-executable instructions embedded on the computer-readable storage device. The memory device includes historical data including sensor measurements. The sensor measurements are received from a plurality of sensors over a time period. The time period at least spans the operation of a replaced component of a particular type immediately preceding and immediately following a repair event in which the replaced component failed and was replaced. The processor receives the historical data from the memory device. When the processor-executable instructions are executed, the processor generates a predictive model which uses, as inputs, sensor measurements in the historical data. The predictive model is able to differentiate between sensor measurements taken before the repair event and sensor measurements taken after the repair event without a time of the repair event being an input to the predictive model. Also, when executed, the processor designates one or more sensor measurements used as inputs to the predictive model as precursors to the failure of the particular type of component.

### DRAWINGS

These and other features, aspects, and advantages will become better understood when the following detailed description is read with reference to the accompanying drawings in which like characters represent like parts throughout the drawings, wherein:

FIG. 1 is a simplified block diagram of a portion of an exemplary computer-based system for identifying a precursor to a failure of a particular type of component in a physical system;

FIG. 2 is a block diagram of an exemplary computing device that may be used in the computer-based system shown in FIG. 1;

FIG. 3 is a flow chart of an exemplary process of the flow of information in the computer-based system shown in FIG. 1; and

FIG. 4 is a flow chart of an exemplary method for identifying a precursor to a failure of a particular type of component in a physical system used in the computer-based system, shown in FIG. 1, using the process shown in FIG. 3.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, the terms “software” and “firmware” are interchangeable, and include any computer program stored in memory for execution by devices that include, without limitation, mobile devices, clusters, personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device,” are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “physical system” and related terms, e.g., “physical systems,” refers to any system composed of one or more parts that has a physical presence. Physical systems may include, without limitation, vehicles, transportation systems, manufacturing facilities, chemical processing facilities, power generation facilities, infrastructure systems, and communication systems. Physical systems may also include, without limitation, complex chemical or biological systems where components of such systems may have sensor measurements associated. Also, as used herein, physical systems are analyzed to find precursors to failure of a particular type of component of the physical system.

As used herein, the term “failure” and related terms, e.g., “failure incidents,” means falling below the desired level of performance. Failure does not require a physical breakdown or adverse consequences for the physical system. Also, as used herein, failure may refer to a particular type of component or a plurality of components not meeting the expected level of performance.

As used herein, the term “precursor” and related terms, e.g., “failure precursor,” means a condition that is known or expected to indicate a subsequent outcome. Also, as used herein, a precursor may have a correlating relationship or a causal relationship to the subsequent outcome.

As used herein, the term “sensors” and related terms, e.g., “sensors,” refers to a device that is attached to a physical system or a component of a physical system that may determine sensor measurements, i.e., measurement data, physical system or the component for a given point in time. Also, as used herein, sensors facilitate the detection of sensor measurements and the transmission of the sensor measurements to the computing device.

As used herein, the term “sensor measurement” and related terms, e.g., “sensor measurements,” refers to a type of measurement data that is sensed by a sensor or a plurality of sensors. The sensor measurements may include, without limitation, data on the mechanical integrity of a component, data on the mechanical operation of a component, data on the chemical state of a component, data on the electrical conductivity of a component, data on the radiation signatures of a component, and data on the temperature of a component. Sensor measurement data may also have been detected previously and represent historical sensor measurement data. Sensor measurement data may further have been detected externally and imported into the system.

As used herein, the term “feature” and related terms, e.g., “feature library,” refers to characteristics of sensor measurements that are of interest in the analysis of the plurality of sensor measurements. Also, as used herein, features facilitate finding precursors to a failure for a particular type of component in the physical system.

As used herein, the term “multivariate fusion” and related terms, e.g., “multivariate fusion analysis,” refers to the observation and analysis of multiple variables at one time. Also, as used herein, multivariate fusion involves bringing sensor measurements from the plurality of sensor measurements into a grouping and simultaneously analyzing all sensor measurements. Additionally, as applied herein, multivariate fusion facilitates determining features that are of interest, creating a predictive model of the physical system, and designating at least one sensor measurement used as an input to the predictive model as a precursor to failure. Further, multivariate fusion may be used to observe and analyze multiple features received from a single sensor. For example, a single sensor may produce a plurality of sensor measurements or a vector comprising sensor measurements. In this case, observing and analyzing features from the single sensor can incorporate multivariate fusion.

As used herein, the term “univariate analysis” and related terms, e.g., “univariate diagnostic index” or “univariate prognostic index,” refers to the observation and analysis of a single variable at one time, in contrast to multivariate fusion. Also, as used herein, univariate fusion involves looking at sensor measurements from a particular sensor and analyzing these sensor measurements in relation to the physical system. Additionally, as applied herein, univariate analysis facilitates creating a predictive model of the physical system.

As used herein, the term “Bayesian analysis” and related terms, e.g., “Bayesian inferences” and “naïve Bayesian classification,” refer to a method of inference which considers the probability of an event in light of a prior probability and a likelihood function derived from existing relevant data. More specifically, Bayesian analysis considers a set of data preceding an outcome, determines what data from that set of data is relevant, and determines an outcome probability based upon the general likelihood of an outcome and the likelihood considering the relevant set of data. Bayesian analysis allows for the constant updating of a predictive model with new sets of evidence. Many known models for applying Bayesian analysis exist including naïve Bayesian classification Bayesian log-likelihood functions. Also, as used herein, Bayesian analysis facilitates distinguishing which sensor measurements are most associated with the failure outcome being evaluated, and distinguishing which sensors are therefore most determinative to such an outcome.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

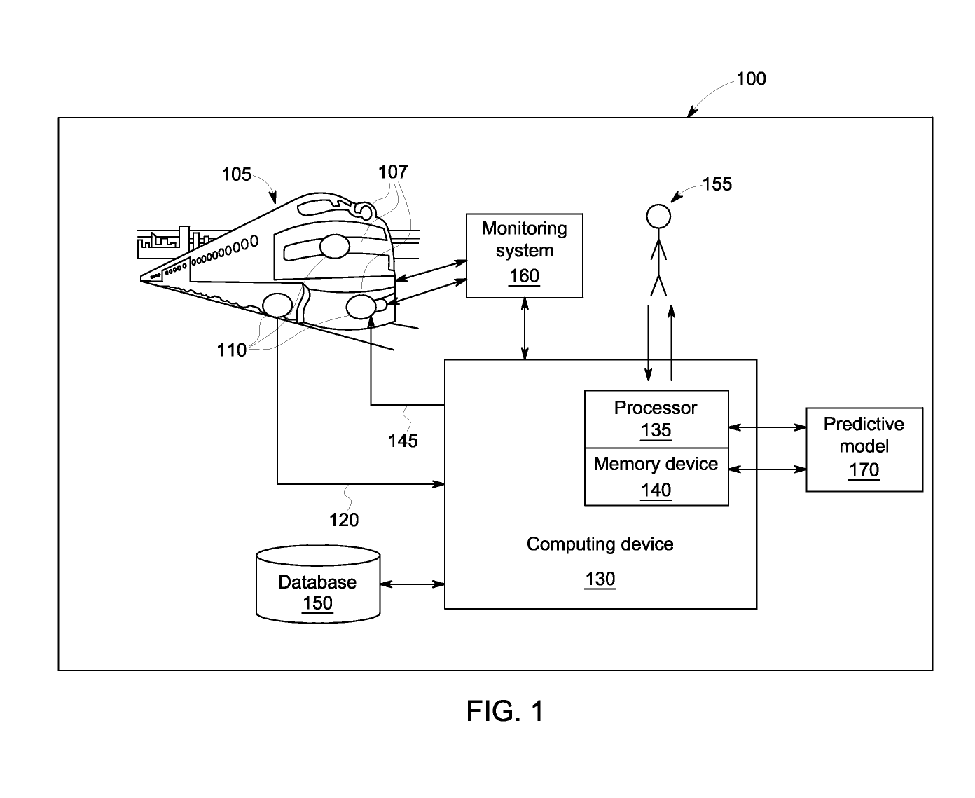

FIG. 1 is a simplified block diagram of a portion of an exemplary computer-implemented system 100 for identifying a precursor to a failure of a particular type of component in a physical system. Computer-implemented system 100 includes a physical system 105 composed of a plurality of components 107. In the exemplary embodiment, physical system 105 is a locomotive and the plurality of components 107 are components of locomotives including, without limitation, locomotive engines, locomotive wheels, locomotive electronics, locomotive brakes, locomotive heating systems, locomotive cooling systems, and locomotive communications systems. In alternative embodiments, physical system 105 can be any physical system 105 including plurality of components 107 and capable of being monitored by a plurality of sensors 110. These alternative embodiments of physical systems 105 may include, without limitation, vehicles, transportation systems, manufacturing facilities, chemical processing facilities, power generation facilities, infrastructure systems, and communication systems. Physical system 105 is coupled to sensors 110. Also, in the exemplary embodiment, sensors 110 are coupled to the wheels, engine, and brakes of physical system 105 represented as a locomotive. In alternative embodiments, sensors 110 can be coupled to any component of the plurality of components 107 of physical system 105.

Computer-implemented system 100 also includes a computing device 130. Computing device 130 includes a processor 135 and a memory device 140. Processor 135 and memory device 140 are coupled to one another. Moreover, in the exemplary embodiment, computing device 130 includes one processor 135 and one memory device 140. In alternative embodiments, computing device 130 may include a plurality of processors 135 and a plurality of memory devices 140. Computing device 130 is associated with a database 150. Furthermore, in the exemplary embodiment, database 150 is manifested as a single database instance. In alternative embodiments, database 150 is manifested as a plurality of database instances.

Moreover, computing device 130 is configured to receive sensor measurements 120 associated with physical system 105 from sensors 110. In the exemplary embodiment, sensor measurements 120 include vibration data, rotational data, and thermal data from plurality of components 107. In alternative embodiments, sensor measurements 120 may include, without limitation, data on the mechanical integrity of a component, and data on the mechanical operation of a component. Also, in other alternative embodiments, sensor measurements 120 may include data on the chemical state of a component, data on the electrical conductivity of a component, data on the radiation signatures of a component, and component thermal data. Further, in additional alternative embodiments, sensor measurements 120 may include a range of time which includes multiple repair events.

In addition, computing device 130 is also configured to store sensor measurements 120 at memory device 140. Computing device 130 receives a plurality of sensor measurements 120 stored at memory device 140. Computing device 130 is configured to receive expert user input (not shown in FIG. 1) associated with an expert user 155. Such input includes expert data representing information obtained by human experts regarding the relationship between sensors 110 and physical system 105.

Furthermore, computer-implemented system 100 includes a monitoring system 160. As used herein, the term “monitoring system” includes any programmable system including systems and microcontrollers, reduced instruction set circuits, application specific integrated circuits, programmable logic circuits, and any other circuit capable of executing the monitoring functions described herein. Monitoring systems may include sufficient processing capabilities to execute support applications including, without limitation, a Supervisory, Control and Data Acquisition (SCADA) system and a Data Acquisition System (DAS). The above examples are exemplary only, and thus are not intended to limit in any way the definition and/or meaning of the term processor. Monitoring system 160 is associated with, and capable of monitoring and communicating with, physical system 105. Monitoring system 160 is also capable of communicating with computing device 130.

In operation, computing device 130 generates a predictive model 170. Computing device 130 generates predictive model 170 using sensor measurements 120 and uses sensors 110 as inputs. In alternative computer-implemented systems 100, computing device 130 generates predictive model 170 using sensor measurements 120 such that a subset of sensors 110 in sensor measurements 120 is used as inputs. In other computer-implemented systems 100, computing device 130 generates predictive model 170 using sensor measurements 120 which includes at least some expert user input received from expert user 155 at computing system 130.

Also, in operation, computing device 130 designates at least one designated sensor measurement 145 to be used as an input to predictive model 170 as a precursor to failure of a particular type of component 107 in physical system 105. Computing device 130 designates designated sensor measurement 145 and updates predictive model 170 and stores designated sensor measurement 145 in memory device 140 and/or database 150. In at least some computer-implemented systems 100, computer device 130 designates designated sensor measurement 145 and transmits designated sensor measurement 145 and at least one mathematical operation of predictive model 170 to monitoring system 160. In such computer-implemented systems 100, monitoring system 160 monitors physical system 105 for sensor measurements 120 that indicate physical system 105 is approaching the end of its remaining useful life.

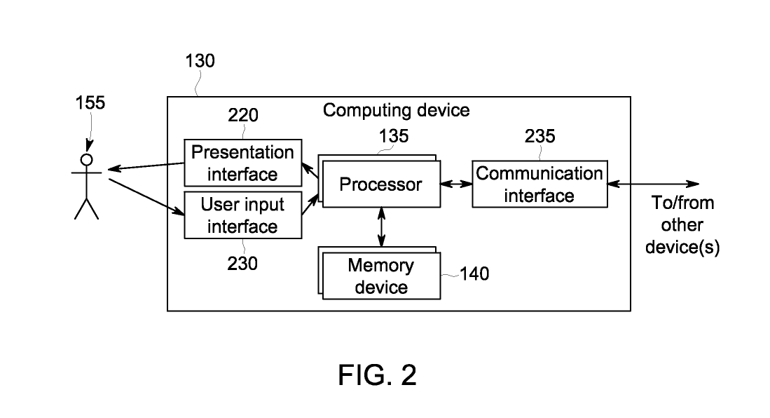

FIG. 2 is a block diagram of computing device 130 used for identifying a precursor to a failure of a particular type of component 107 in physical system 105 (both shown in FIG. 1). Computing device 130 includes a memory device 140 and a processor 135 operatively coupled to memory device 140 for executing instructions. Processor 135 may include one or more processing units. In some embodiments, executable instructions are stored in memory device 140. Computing device 130 is configurable to perform one or more operations described herein by programming processor 135. For example, processor 135 may be programmed by encoding an operation as one or more executable instructions and providing the executable instructions in memory device 140.

In the exemplary embodiment, memory device 140 is one or more devices that enable storage and retrieval of information such as executable instructions and/or other data. Memory device 140 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Memory device 140 may be configured to store sensor measurements 120 (shown in FIG. 1) including, without limitation, vibration data, chemical data, thermal data, electrical data, and/or any other type of data. In some embodiments, processor 135 removes or “purges” data from memory device 140 based on the age of the data. For example, processor 135 may overwrite previously recorded and stored data associated with a subsequent time and/or event. In addition, or alternatively, processor 135 may remove data that exceeds a predetermined time interval. Also, memory device 140 includes, without limitation, sufficient data, algorithms, and commands to facilitate identifying a precursor to a failure of a particular type of component 107 in a physical system 105 (discussed below).

In some embodiments, computing device 130 includes a user input interface 230. In the exemplary embodiment, user input interface 230 is coupled to processor 135 and receives input from expert user 155. User input interface 230 may include, for example, a keyboard, a pointing device, a mouse, a stylus, a touch sensitive panel, including, e.g., without limitation, a touch pad or a touch screen, and/or an audio input interface, including, e.g., without limitation, a microphone. A single component, such as a touch screen, may function as both a display device of presentation interface 220 and user input interface 230.

A communication interface 235 is coupled to processor 135 and is configured to be coupled in communication with one or more other devices, such as a sensor or another computing device 130, and to perform input and output operations with respect to such devices. For example, communication interface 235 may include, without limitation, a wired network adapter, a wireless network adapter, a mobile telecommunications adapter, a serial communication adapter, and/or a parallel communication adapter. Communication interface 235 may receive data from and/or transmit data to one or more remote devices. For example, a communication interface 235 of one computing device 130 may transmit an alarm to the communication interface 235 of another computing device 130. Communications interface 235 facilitates machine-to-machine communications, i.e., acts as a machine-to-machine interface.

Presentation interface 220 and/or communication interface 235 are both capable of providing information suitable for use with the methods described herein, e.g., to expert user 155 or another device. Accordingly, presentation interface 220 and communication interface 235 may be referred to as output devices. Similarly, user input interface 230 and communication interface 235 are capable of receiving information suitable for use with the methods described herein and may be referred to as input devices. In some embodiments, expert user 155 uses presentation interface 220 and/or communication interface 235 to input expert user input (not shown in FIG. 2) into computing system 130. In at least some other embodiments user expert 155 uses presentation interface 220 and/or communication interface 235 to review a plurality of candidate models determining precursors to failure for particular type of component 107 in physical system 105.

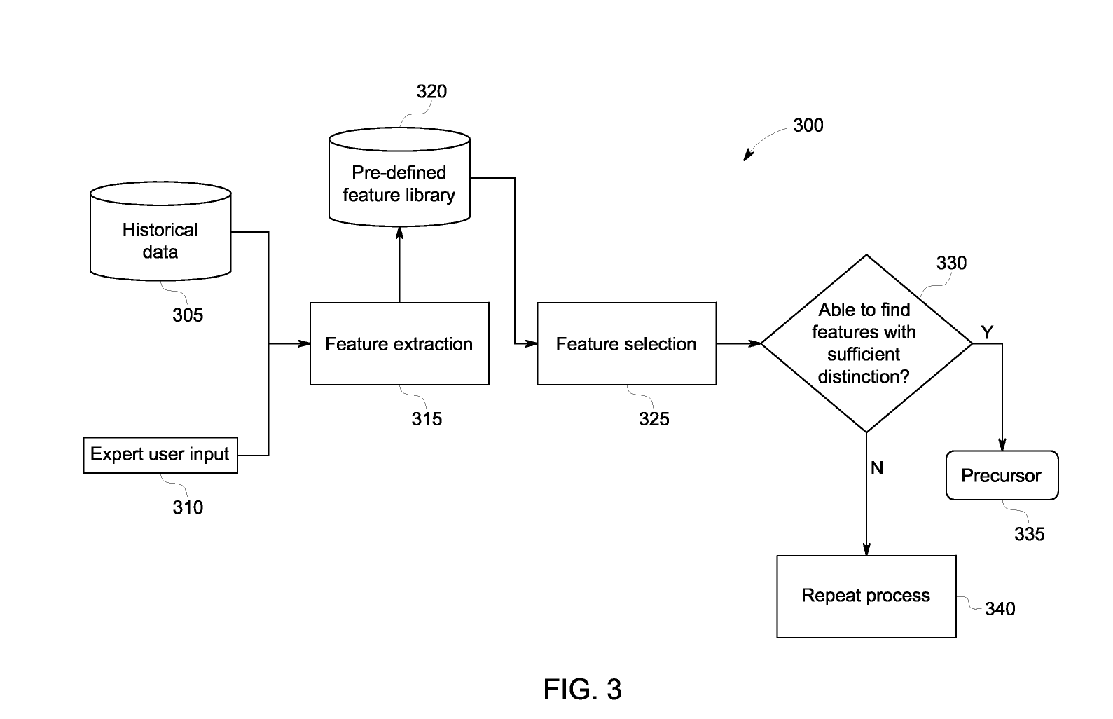

FIG. 3 is a flow chart of an exemplary process 300 of the flow of information in computer-based system 100 (shown in FIG. 1). In the exemplary embodiment, expert user input 310 associated with expert user 155 (shown in FIG. 1) and historical data 305 are received from memory device 140 (shown in FIG. 1). Historical data 305 is representative of historical sensor measurements received as sensor measurements 120 (shown in FIG. 1). Feature extraction 315 is performed upon expert user input 310 associated with expert user 155 (shown in FIG. 1) and upon historical data 305. Feature extraction 315 represents selecting data from expert user input 310 and historical data 305 and preparing selected data for processing. In at least some embodiments, a pre-defined feature library 320 is applied to the extracted feature data 315. In the at least some embodiments, pre-defined feature library 320 is used to pre-determine which features are likely to be more or less relevant to predictive model 170 (shown in FIG. 1).

Additionally, features are selected 325 from features extracted 315. In the exemplary embodiment, feature selection 325 substantially represents generating predictive model 170 to determine a precursor to failure of a particular component in physical system 105 (shown in FIG. 1). Feature selection may include, without limitation, Bayesian analysis, log-likelihood analysis, adaptive modeling, and any other mathematical or computational operation capable of determining which feature 325 may be a precursor to a failure of a particular component in physical system 105 (shown in FIG. 1).

Furthermore, the method determines 330 whether features 325 selected are sufficiently distinct to identify precursors. In the exemplary embodiment, distinction can be set by, without limitation, a threshold within the system, a standard system requirement of prediction quality, or expert user 155 determined requirement (not shown) of prediction quality. If features selected 325 are not determined 330 to be sufficiently distinct, the process is repeated 340. If features 325 selected are determined 330 to be sufficiently distinct, feature 325 is identified as a precursor 335 and can be associated to sensor measurements 120 detected by designated sensor 145 (shown in FIG. 1).

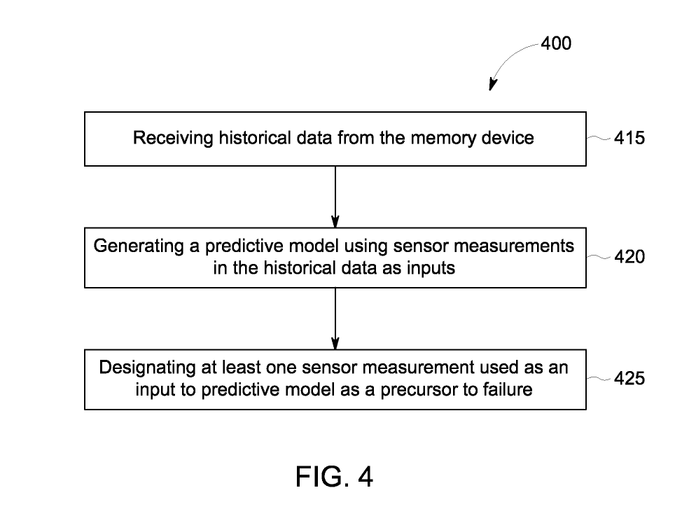

FIG. 4 is a flow chart of an exemplary method 400 for identifying a precursor to a failure of a particular type of component 107 in physical system 105 (both shown in FIG. 1) using process 300 (shown in FIG. 3). Historical data 305 (shown in FIG. 3) is received 415 from memory device 140 (shown in FIG. 1). In the exemplary embodiment, historical data 305 includes data received from sensors 110 (shown in FIG. 1) as sensor measurements 120 (shown in FIG. 1) obtained from physical system 105. In alternative embodiments, historical data 305 further includes sensor measurements 120 obtained from physical systems distinct from, but similar to, physical system 105. In other embodiments, historical data 305 further includes sensor measurements 120 obtained from simulations of physical system 105.

Also, predictive model 170 (shown in FIG. 1) is generated 420 using sensor measurements 120 in historical data 305 as inputs. In at least some embodiments, generating 420 predictive model 170 uses a subset of sensor measurements 120 in historical data 305 as inputs. In other embodiments, generating 420 predictive model 170 uses a single sensor measurement 120 as an input and conducts a univariate analysis. The univariate analysis may include, without limitation, any mathematical function of single sensor measurement 120.

Further, in the exemplary embodiment, generating 420 predictive model 170 involves combining at least two sensor measurements 120 in a mathematical operation. Mathematical operation generally involves a process of multivariate fusion where multiple sensor measurements 120 are evaluated as outcome variables simultaneously. Multivariate fusion may involve, without limitation, factor analysis, polynomial equations, adaptive modeling, or any other known or discovered mathematical operation.

Moreover, in at least some embodiments, historical data 305 received spans multiple repair events. In these embodiments, generating 420 predictive model 170 involves generating a plurality of candidate predictive models (not shown) where the plurality of candidate predictive models use a random selection of sensor measurements 120 as inputs. Also, in the at least some embodiments, generating 420 predictive model 170 further involves determining which of the plurality of candidate predictive models most accurately differentiates between sensor measurements 120 taken before a repair event and sensor measurements 120 taken after a repair event. Further, these embodiments, generating 420 predictive model 170 also involves designating as predictive model 170 the most accurate of the plurality of candidate predictive models.

Furthermore, in some embodiments, historical data 305 includes expert user input 310 (shown in FIG. 3) associated with expert user 155 (shown in FIG. 1). In these embodiments, generating 420 predictive model 170 also involves using at least some expert user input 310 associated with expert user 155. Such expert user input 310 associated with expert user 155 may include, without limitation, specific sensor measurements 120 designated as related to each other by expert user 155, specific sensor measurements 120 designated as unrelated by expert user 155, and combinations of specific sensor measurements 120 designated as related to each other by expert user 155. In these embodiments, generating 420 predictive model 170 involves distinguishing the significance of expert user input 310 associated with expert user 155 from other historical data 305. Distinguishing may be accomplished by methods including, without limitation, multivariate fusion, Bayesian analysis, and the use of feature libraries.

Also, in the exemplary embodiment, generating 420 a predictive model 170 involves feature selection 325 (shown in FIG. 3) to distinguish which sensor measurements 120 are precursors to the failure of the particular type of component 107. In at least some embodiments, feature selection 325 includes the use of pre-defined feature library 320 (shown in FIG. 3) which is stored in database 150 (shown in FIG. 1). Pre-defined feature library 320 facilitates the identification and selection of features which facilitates generating 420 predictive model 170.

Further, at least one designated sensor measurement 145 (shown in FIG. 1) used as an input to a predictive model 170 is designated 425 as a precursor to failure. In at least some embodiments, a combination of designated sensor measurements 145 are designated as a precursor to failure. In alternative embodiments, designating 425 at least one designated sensor measurement 145 involves transmitting the designation of at least one designated sensor measurement 145 to monitoring system 160 (shown in FIG. 1) which may monitor physical system 105.

The computer-implemented systems and methods as described herein facilitate increasing the remaining useful life of a physical system. Also, such systems and methods facilitate reducing the cost of servicing the physical system. Further, such systems and methods facilitate improving the monitoring of the physical system by identifying sensors that are precursors to failure for a particular type of component in the physical system.

A technical effect of systems and methods described herein includes at least one of: (a) enhancing the remaining useful life of physical systems by enabling monitoring of the most important sensors for failure of components in the physical system; (b) reducing the time to identify a failure of components in the physical system by focusing on the most important sensors for failure of components in the physical system; and (c) facilitating identification of precursors to failure by expediting the analysis of complex sensor data as precursors to failure for components of the physical system.

Exemplary embodiments of computer-implemented systems and methods for identifying a precursor to a failure of a component in a physical system are described above in detail. The computer-implemented systems and methods of operating such systems are not limited to the specific embodiments described herein, but rather, components of systems and/or steps of the methods may be utilized independently and separately from other components and/or steps described herein. For example, the methods may also be used in combination with other enterprise systems and methods, and are not limited to practice with only the methods and systems for identifying a precursor to a failure of a component in a physical system, as described herein. Rather, the exemplary embodiment can be implemented and utilized in connection with many other enterprise applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented system for identifying a precursor to a failure of a particular type of component in a physical system, the physical system having a plurality of sensors coupled to components of the physical system, said computer-implemented system comprising:
a computing device;
a database associated with said computing device;
a processor coupled to said computing device; and
a memory device coupled to said processor and to said computing device, said memory device including historical data including sensor measurements from the plurality of sensors over a time period, wherein the time period at least spans operation of a replaced component of the particular type immediately preceding and immediately following a repair event in which the replaced component failed and was replaced, said memory device further including processor-executable instructions that, when executed by said processor, cause said processor to:
receive the historical data from said memory device;
generate a predictive model which uses, as inputs, sensor measurements in the historical data, wherein said predictive model is able to differentiate between sensor measurements taken before the repair event and sensor measurements taken after the repair event, without a time of the repair event being an input to the predictive model; and
designate at least one sensor measurement used as inputs to said predictive model as precursors to the failure of the particular type of component.

2. The computer-implemented system of claim 1, wherein said memory device including processor-executable instructions to generate said predictive model further including process-executable instructions to generate said predictive model which uses, as inputs, a subset of the sensor measurements in the historical data.

3. The computer-implemented system of claim 1, wherein said memory device further includes processor-executable instructions to generate said predictive model such that said predictive model that combines at least two sensor measurements in a mathematical operation.

4. The computer-implemented system of claim 1, wherein said memory device further includes historical data including sensor measurements from the plurality of sensors over a time period, where the time period includes multiple repair events.

5. The computer-implemented system of claim 4, wherein said memory device further includes processor-executable instructions that, when executed, cause said processor to generate said predictive model and to further:
generate a plurality of candidate predictive models, wherein said plurality of candidate predictive models use a random selection of sensor measurements as inputs;
determine which of said plurality of candidate predictive models most accurately differentiates between sensor measurements taken before the repair events and sensor measurements taken after the repair events; and
designate, as said predictive model, a most accurate candidate predictive model from said plurality of candidate predictive models.

6. The computer-implemented system of claim 4, wherein said memory device further includes processor-executable instructions that, when executed by said processor, designates the at least one sensor measurement as precursors to the failure of the particular type of component cause said processor to further:
designate a combination of sensor measurements, combined with at least one mathematical operation of the predictive model, as a precursor to failure; and
transmit the designated combination of sensor measurements and the at least one mathematical operation of the predictive model to a monitoring system, the monitoring system monitors the physical system.

7. The computer-implemented system of claim 1, wherein said memory device further includes processor-executable instructions that, when executed, cause said processor to receive the historical data from said memory device and to further:
receive expert data from said memory device, the expert data associated with the historical data, the expert data substantially representing information obtained by human experts regarding the relationship between the plurality of sensors and the physical system; and
generate said predictive model using at least some of the expert data.

8. A computer-implemented method for identifying a precursor to a failure of a particular type of component in a physical system, the physical system having a plurality of sensors coupled to components of the physical system, the method is performed by a computing device including:
a processor coupled to a memory device and associated with a database, said memory device including historical data including sensor measurements from the plurality of sensors over a time period, wherein the time period at least spans an operation of a replaced component of the particular type immediately preceding and immediately following a repair event in which the replaced component failed and was replaced, said method comprising:
receiving the historical data from said memory device;
generating a predictive model which uses, as inputs, sensor measurements in the historical data, wherein the predictive model is able to differentiate between sensor measurements taken before the repair event and sensor measurements taken after the repair event, without a time of the repair event being an input to the predictive model; and
designating at least one sensor measurement used as inputs to the predictive model as precursors to the failure of the particular type of component.

9. The computer-implemented method of claim 8, wherein generating said predictive model comprises generating a predictive model which uses, as inputs, a subset of the sensor measurements in the historical data.

10. The computer-implemented method of claim 8, wherein generating said predictive model comprises generating a predictive model that combines at least two sensor measurements in a mathematical operation.

11. The computer-implemented method of claim 8, wherein the time period includes multiple repair events.

12. The computer-implemented method of claim 11, wherein generating the predictive model comprises:
generating a plurality of candidate predictive models, wherein said plurality of candidate predictive models use a random selection of sensor measurements as inputs;
determining which of said plurality of candidate predictive models most accurately differentiates between sensor measurements taken before the repair events and sensor measurements taken after the repair events; and
designating, as said predictive model, a most accurate candidate predictive model from said plurality of candidate predictive models.

13. The computer-implemented method of claim 11, wherein designating the at least one sensor measurement as precursors to the failure of the particular type of component further comprises:
designating a combination of sensor measurements, combined with at least one mathematical operation of the predictive model, as a precursor to the failure; and
transmitting the designated combination of sensor measurements and the at least one mathematical operation of the predictive model to a monitoring system, the monitoring system monitors the physical system.

14. The computer-implemented method of claim 8, further comprising:
receiving expert data from said memory device, the expert data associated with the historical data, the expert data substantially representing information obtained by human experts regarding the relationship between the plurality of sensors and the physical system; and
generating said predictive model using at least some the expert data.

15. A computer-readable storage device having processor-executable instructions embodied thereon, wherein, when executed by at least one processor coupled to a memory device in a computing device, said memory device including historical data including sensor measurements from a plurality of sensors over a time period, the time period at least spanning operation of a replaced component of a particular type immediately preceding and immediately following a repair event in which the replaced component failed and was replaced, cause the at least one processor to:
receive the historical data from said memory device;
generate a predictive model which uses, as inputs, sensor measurements in the historical data, wherein the predictive model is able to differentiate between sensor measurements taken before the repair event and sensor measurements taken after the repair event, without a time of the repair event being an input to the predictive model; and
designate at least one sensor measurement used as inputs to the predictive model as precursors to the failure of the particular type of component.

16. The computer-readable storage device of claim 15, wherein said computer-readable storage device further has processor-executable instructions that generate a predictive model such that the predictive model uses, as inputs, a subset of the sensor measurements in the historical data.

17. The computer-readable storage device of claim 15, wherein said computer-readable storage device further has processor-executable instructions that generate a predictive model such that the predictive model combines at least two sensor measurements in a mathematical operation.

18. The computer-readable storage device of claim 15, wherein the time period includes multiple repair events.

19. The computer-readable storage device of claim 18, wherein said computer-readable storage device further has processor-executable instructions that generate further has processor-executable instructions that:
generate a plurality of candidate predictive models, wherein each predictive model uses a random selection of sensor measurements as inputs;
determine which of the plurality of candidate predictive models most accurately differentiates between sensor measurements taken before the repair events and sensor measurements taken after the repair events; and
designate the most accurate candidate predictive model as the predictive model.

20. The computer-readable storage device of claim 18, wherein said computer-readable storage device further has processor-executable instructions that generate further has processor-executable instructions that:
designate a combination of sensor measurements, combined with at least one mathematical operation of the predictive model, as a precursor to failure; and
transmit the designated combination of sensor measurements and the at least one mathematical operation of the predictive model to a monitoring system, the monitoring system monitors the physical system.
